(19) United States
(12) Patent Application Publication
(10) Pub. No.: US 2016/0221750 A1
(43) Pub. Date: Aug. 4, 2016

(54) FEMININE HYGIENE WASTE DISPOSAL CONTAINER

(71) Applicant: Christian Chanel Cavaletti, Los Angeles, CA (US)

(72) Inventor: Christian Chanel Cavaletti, Los Angeles, CA (US)

(21) Appl. No.: 14/728,876

(22) Filed: Jun. 2, 2015

Related U.S. Application Data
(60) Provisional application No. 62/109,770, filed on Jan. 30, 2015.

(51) Int. Cl. B65F 1/06; B65F 1/14

(52) U.S. Cl. CPC B65F 1/06; B65F 1/1623; B65F 1/1607; B65F 1/1415; B65F 2001/1676

(57) ABSTRACT

A feminine hygiene waste disposal container. The feminine hygiene waste disposal container may comprise: a body, lid, front panel, two telescopic guide rails, two first fasteners, and a disposable bag. The body may comprise a top open end and a front open end. The lid may be pivotally mounted on the top open end of the body via a hinge. The front panel may be connected to a proximal end of the two telescopic guide rails. A distal end of the two telescopic guide rails may be connected to an inner cavity of the body through the front open end and may be adapted to be pushed towards the inner cavity of the body in a guiding direction. The two first fasteners may be positioned approximately near a proximal end portion of the telescopic guide rails and may be adapted to securely hold and secure the disposable bag.

### CROSS-REFERENCE TO RELATED APPLICATIONS

This application claims the benefit of U.S. Provisional Patent Application No. 62/109,770, filed on Jan. 30, 2015, titled “Feminine Hygiene Waste Disposal Container”, by sole inventor Christian Chanel Cavaletti, the contents of which are expressly incorporated herein by this reference, and to which priority is claimed

### FIELD OF USE

The present disclosure relates generally to waste containers, and more particularly, to waste containers for discretely storing of and disposing of used feminine hygiene products.

### BACKGROUND

Proper waste disposal of used feminine hygiene products such as used tampons and pads is preferably discarded by women with discretion. Currently available waste containers that are used to dispose of used feminine hygiene products typically include traditional trash bins and trash cans.

Unfortunately, many trash bins and trash cans lack covers and lids. Thus, the contents therein are generally observable by the public. As a result, the public is unnecessarily exposed to these waste containers, which are messy, noticeable, and usually fail to conceal unpleasant odors. While many trash bins are configured to utilize liners, these trash containers frequently do not come furnished with liners and liners are not generally required for most trash containers. Additionally, these liners may not be adapted to be affixed to trash containers, making installation of these liners difficult and time consuming. Improperly installed liners may fall to the bottom of the trash containers making an even bigger mess.

Regarding waste bins that do have lids, these waste bins are similar to general household trash bins situated in bathrooms and kitchens found in a home and are frequently unsuitable for hygiene product waste. Thus, these waste containers fail to store used hygiene products without interaction with general waste. As such, these waste bins generally do not allow women to discard and store their used hygiene products discretely from family members or household guests.

Importantly, most waste bins do not generally include custom disposable bags that are used to effectively seal and replace used feminine hygiene products. These bags also generally do not fully mask and conceal the odor of those products. Rather, a user typically must remove the disposable bag and manually tie a knot to seal the open end of the bag.

On the other hand, regarding those waste bins that utilize custom disposable bags, these bags still generally do not allow a user to easily seal an open end of the bag. For example, Playtex®'s Diaper Genie® utilizes a custom refill disposable bag system that allows a user to easily remove and replace additional bags. The Diaper Genie® refill bag system preferably utilizes a ring container that contains plurality of disposable bags inside. The Diaper Genie® refill bag system is installed to the Playtex® disposal waste bin, and users can quickly remove and replace bags by pulling a new full bag from the ring container when disposing the full bag. Unfortunately, these disposable bags do not have an effective mechanism to quickly and easily seal a bag, and usually still require that the user to manually seal and tie the open end of the bag.

Therefore, there is a need for a waste device for the disposal of feminine hygiene products that is discreet, simple, and minimizes human contact and observation with the waste. Preferably, the new device may: (1) store used sanitary pads; (2) allow a discrete means for disposal; (3) provide a simpler way to deal with remnants of used female hygiene materials at home; and (4) provide the option of utilizing custom disposable bags for easy replacement and sealing.

### SUMMARY OF EMBODIMENTS

To minimize the limitations in the prior art, and to minimize other limitations that will become apparent upon reading and understanding the present disclosure, the present specification discloses a new and improved feminine hygiene waste disposal container.

One embodiment may be a feminine hygiene waste disposal container, comprising: a body, a lid, a front panel, one or more guide rails, and one or more first fasteners; wherein the body comprises a top open end and a front open end; wherein the top open end and the front open end provides access to an inner cavity of the body; wherein the lid is removeably mounted on the top open end of the body and is adapted to substantially cover the top open end; wherein the front panel is connected to a proximal ends of the one or more guide rails; wherein a distal ends of the one or more guide rails are connected to the inner cavity of the body through the front open end and are adapted to be pushed onto a rear receiving fitting on the inner cavity of the body in a guiding direction, such that the front panel can be engaged with the front open end of the body; and wherein the one or more first fasteners are positioned approximately near a proximal end portion of the guide rails and are adapted to securely hold and secure at least one disposable bag, such that, when the front panel is engaged with the front open end of the body and when the lid is in the closed position, the at least one disposable bag is substantially concealed. The one or more guide rails may be telescopic guide rails. The lid may be pivotally mounted on the top open end of the body via a hinge, such that the lid is configured to be selectively movable between an open position and a closed position. The at least one disposable bag may comprise a ring and one or more second fasteners; wherein the ring may be attached to a rim of the at least one disposable bag, such that an inner opening of the ring may provide sole access to the inner cavity of the at least one disposable bag; and wherein the one or more second fasteners may be located on the ring and may be adapted to matingly engage with the one or more first fasteners, such that the at least one disposable bag may removeably connect to the proximal end portion of the one or more telescopic guide rails and may be held steady by the one or more telescopic guide rails. The inner cavity of the at least one disposable bag may be accessible when the front panel is away from the body and when the one or more telescopic guide rails are substantially extended. The ring may comprise one or more hinges to fold a first ring portion towards a second ring portion, such that the at least one disposable bag may be adapted to move between an open position and a closed position. The one or more second fasteners of the at least one disposable bag may be two fasteners, a male second fastener and a female second fastener; and wherein the male second fastener and the female second fastener may be adapted to mate and engage with each another, such that the first ring portion may be fastened to the second ring portion to securely close the at least one disposable bag. The front panel may further comprise a handle; wherein the handle may be adapted to allow a user to pull the front panel away from the body and may extend the one or more telescopic guide rails. The feminine hygiene waste disposal container may further comprise an opening mechanism; wherein the opening mechanism may be adapted to pivotally open the lid to the open position. The opening mechanism may be selected from the group of opening mechanisms consisting of: a button and a switch. The feminine hygiene waste disposal container may further comprise: a gasket; wherein the gasket may be located at an inner portion of the lid and may be adapted to seal the top open end of the body when the lid is in the close position to prevent an odor from emanating from the feminine hygiene waste disposal container.

Another embodiment may be a feminine hygiene waste disposal container, comprising: a body, a lid, a front panel, at least two telescopic guide rails, at least two first fasteners, and at least one disposable bag; wherein the body comprises a top open end and a front open end; wherein the top open end and the front open end provides access to an inner cavity of the body; wherein the lid is pivotally mounted on the top open end of the body via a hinge and is adapted to substantially cover the top open end; wherein the lid is configured to be selectively movable between an open position and a closed position; wherein the front panel is connected to a proximal ends of the at least two telescopic guide rails; wherein a distal ends of the at least two telescopic guide rails are connected to the inner cavity of the body through the front open end and are adapted to be pushed onto a rear receiving fitting on the inner cavity of the body in a guiding direction, such that the front panel can be engaged with the front open end of the body; and wherein the at least two first fasteners are positioned approximately near a proximal end portion of the telescopic guide rails and are adapted to securely hold and secure the at least one disposable bag, such that, when the front panel is engaged with the front open end of the body and when the lid is in the closed position, the at least one disposable bag is substantially concealed. The at least one disposable bag may comprise a ring and at least two second fasteners; wherein the ring may be attached to a rim of the at least one disposable bag, such that an inner opening of the ring may provide sole access to the inner cavity of the at least one disposable bag; and wherein the at least two second fasteners may be located on the ring and may be adapted to matingly engage with the at least two first fasteners, such that the at least one disposable bag may removeably connect to the proximal end portion of the at least two telescopic guide rails and may be held steady by the at least two telescopic guide rails. The inner cavity of the at least one disposable bag may be accessible when the front panel is away from the body and when the at least two telescopic guide rails are substantially extended. The ring may comprise at least two hinges to fold a first ring portion towards a second ring portion, such that the at least one disposable bag is adapted to move between an open position and a closed position. The at least two second fasteners of the at least one disposable bag may be two fasteners, a male second fastener and a female second fastener; and wherein the male second fastener and the female second fastener may be adapted to mate and engage with each another, such that the first ring portion may be fastened to the second ring portion to securely close the at least one disposable bag. The front panel may further comprises a handle; wherein the handle may be adapted to allow a user to pull the front panel away from the body and extend the at least two telescopic guide rails. The feminine hygiene waste disposal container may further comprise an opening mechanism; wherein the opening mechanism may be adapted to pivotally open the lid to the open position. The feminine hygiene waste disposal container may further comprise: a gasket; wherein the gasket may be located at an inner portion of the lid and may be adapted to seal the top open end of the body when the lid is in the close position to prevent an odor from emanating from the feminine hygiene waste disposal container.

Another embodiment may be a feminine hygiene waste disposal container, comprising: a body, a lid, a front panel, two telescopic guide rails, two first fasteners, a disposable bag, an opening mechanism, and a gasket; wherein the body comprises a top open end and a front open end; wherein the top open end and the front open end provides access to an inner cavity of the body; wherein the lid is pivotally mounted on the top open end of the body via a hinge and is adapted to substantially cover the top open end; wherein the lid is configured to be selectively movable between an open position and a closed position; wherein the front panel is connected to a proximal ends of the two telescopic guide rails; wherein a distal ends of the two telescopic guide rails are connected to the inner cavity of the body through the front open end and are adapted to be pushed onto a rear receiving fitting on the inner cavity of the body in a guiding direction, such that the front panel can be engaged with the front open end of the body; wherein each of the two first fasteners are positioned approximately near a proximal end portion of each of the telescopic guide rails and are adapted to securely hold and secure the disposable bag, such that, when the front panel is engaged with the front open end of the body and when the lid is in the closed position, the disposable bag is substantially concealed; wherein the disposable bag comprises a ring and two second fasteners; wherein the ring is attached to a rim of the disposable bag, such that an inner opening of the ring provides sole access to the inner cavity of the disposable bag; wherein the two second fasteners are located on the ring and are adapted to matingly engage with the two first fasteners, such that the disposable bag may removeably connect to the proximal end portion of the two telescopic guide rails and may be held steady by the two telescopic guide rails; wherein the inner cavity of the disposable bag is accessible the front panel is away from the body and when the two telescopic guide rails are substantially extended; wherein the ring is foldable to a substantially semicircular shape, such that the inner cavity of the disposable bag may be closed; wherein the ring comprises two hinges to fold a first ring portion towards a second ring portion, such that the disposable bag is adapted to move between an open position and a closed position; wherein the two second fasteners of the at least one disposable bag are a male second fastener and a female second fastener; wherein the male second fastener and the female second fastener are adapted to mate and engage with each another, such that the first ring portion may be fastened to the second ring portion to securely close the at least one disposable bag; wherein the front panel further comprises a handle; wherein the handle is adapted to allow a user to pull the front panel away from the body and extend the two telescopic guide rails; wherein the opening mechanism is adapted to pivotally open the lid to the open position; and wherein the gasket is located at an inner portion of the lid and is adapted to seal the top open end of the body when the lid is in the close position to prevent an odor from emanating from the feminine hygiene waste disposal container.

The present specification discloses a feminine hygiene waste disposal container. The container may comprise two openings (i.e., a top open end and a front open end). One or more guide rails, which may be telescopic, may be connected in-between the inner cavity of the container and a front panel, such that the front panel may open horizontally, similar to a drawer. The front panel may also comprise a handle for allowing the user to pull the front panel outwards and away from the body of the container. When extended, the telescopic guide rails may allow the user to access the inner cavity of the container and allow the user to attach one or more disposable bags on the telescopic guide rails. The top portion of the feminine hygiene waste disposal container may also comprise a lid for access to the inner cavity of the container. The feminine hygiene waste disposal container may also comprise a gasket located at the top open end of the container to prevent odors from seeping out. The lid may also open upon activation of an opening mechanism such as a button or switch.

In one embodiment, the feminine hygiene waste disposal container may be approximately between 7.5 to 15 inches tall and approximately between 8 to 13 inches in diameter. In this embodiment, the lid may be approximately between 6 to 9 inches in diameter. The lid may be connected to the body of the container by a hinged mechanism. The lid may open approximately between 100 to 145 degrees upon activation of an opening mechanism. The container may comprise a gasket constructed of thin rubber and may be located either the top open end of the container or within the inner portion of the lid, such that when the lid is closed, the gasket may create a seal to prevent odors from seeping out.

In a preferred embodiment, the feminine hygiene waste disposal container may be approximately 10 inches tall and approximately 10 inches in diameter. In this embodiment, the lid may be approximately 8 inches in diameter. The lid may be connected to the body of the container by a hinged mechanism. The lid may open approximately 120 degrees when upon activation of an opening mechanism. The lid may comprise a gasket constructed of thin rubber and may be located on the inner portion of the lid, such that when the lid is closed, the gasket may create a seal to prevent odors from seeping out.

It is an object to provide a feminine hygiene waste disposal container that is discreet, easy to use, and minimizes human contact, observation, and exposure with the waste.

It is an object to: (1) provide storage for used sanitary pads; (2) allow a discrete means for disposal; and (3) provide a simpler or easier to use way to deal with remnants of used female hygiene materials at home.

It is an object to provide a feminine hygiene waste disposal container that utilizes disposable bags. The front portion of the container may function as a door to hold and store the disposable bags. The top portion of the container may comprise a lid that may open and close to provide access to a top opening where remnants of used hygiene products are placed and stored for disposal. Preferably, the disposable bags may seal and shut to minimize spills, odors, and/or content.

It is an object to provide a feminine hygiene waste disposal container that is not messy and preferably conceals unpleasant odors. This container may then be used to provide a way for women to dispose their used pads discretely.

It is an object to provide one or more disposable bags, wherein the disposable bags may comprise at least two fasteners—a male fastener and a female fastener. The male fastener and female fastener are preferably adapted to close and seal any contents within the disposable bags. The male fastener and female fastener of the disposable bags may also be adapted to mate and engage with the fasteners on the telescopic guide rails.

It is an object to provide a new and improved device that facilitates the disposal of feminine hygiene products in a discreet and simple manner.

It is also an object to provide a new and improved device that allows for the disposal of feminine hygiene products in a manner that minimizes human contact and observation with the waste.

It is an object to overcome the deficiencies of the prior art.

These, as well as other components, steps, features, objects, benefits, and advantages, will now become clear from a review of the following detailed description of illustrative embodiments, of the accompanying drawings, and of the claims.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

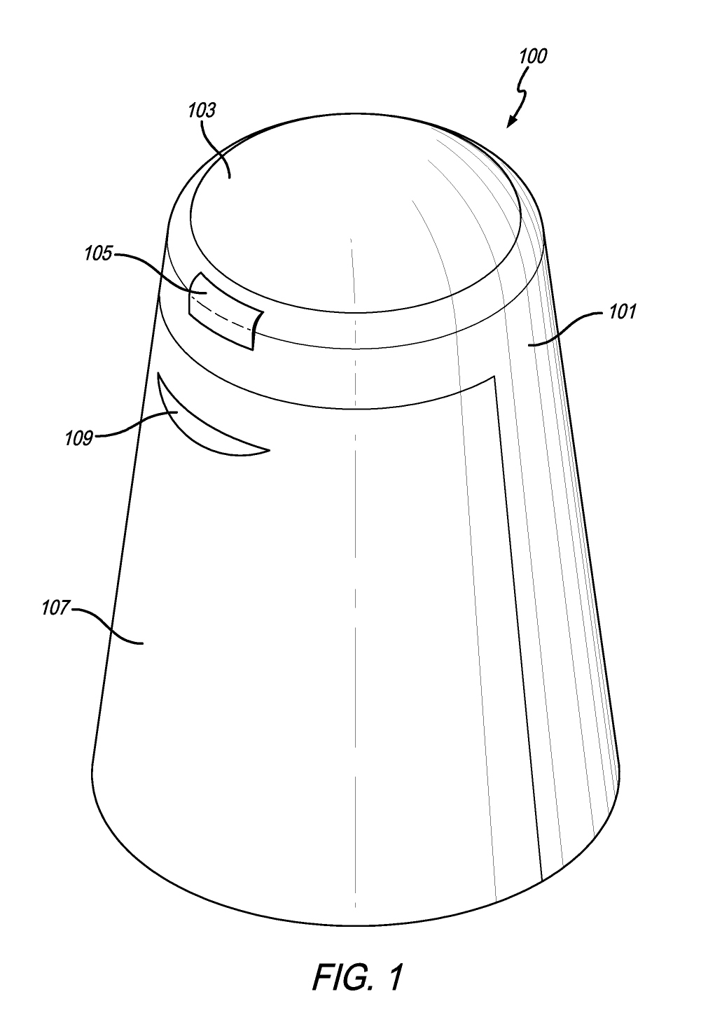

FIG. 1 is an illustration of a perspective view of one embodiment of the feminine hygiene waste disposal container.

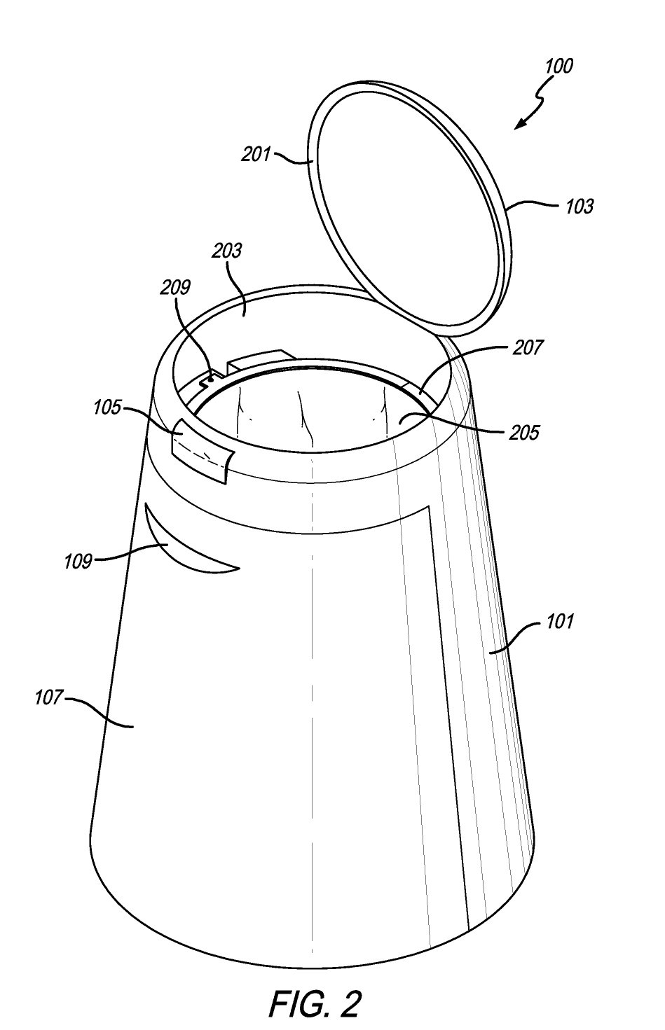

FIG. 2 is an illustration of another perspective view of one embodiment of the feminine hygiene waste disposal container and shows the feminine hygiene waste disposal container with the lid in an open position.

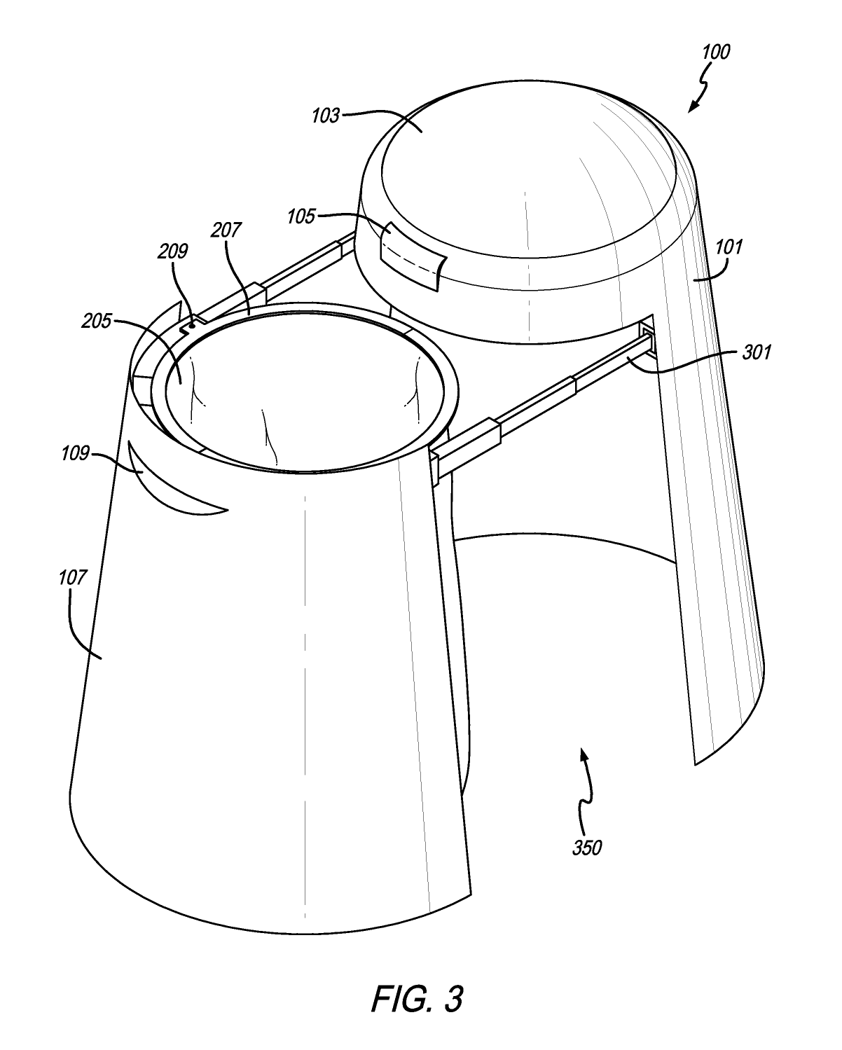

FIG. 3 is an illustration of another perspective view of one embodiment of the feminine hygiene waste disposal container and shows the front panel away from the body with the telescopic guide rails extended.

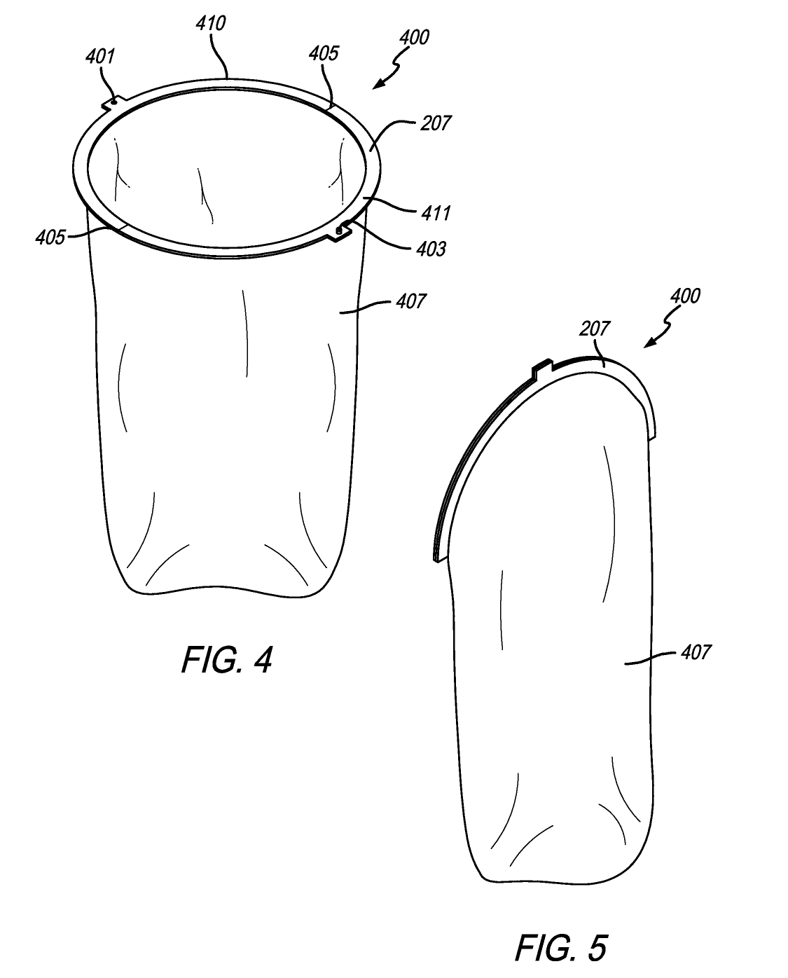

FIG. 4 is an illustration of a perspective view of one embodiment of the disposable bag.

FIG. 5 is an illustration of a perspective view of one embodiment of the disposable bag and shows the disposable bag in a closed position.

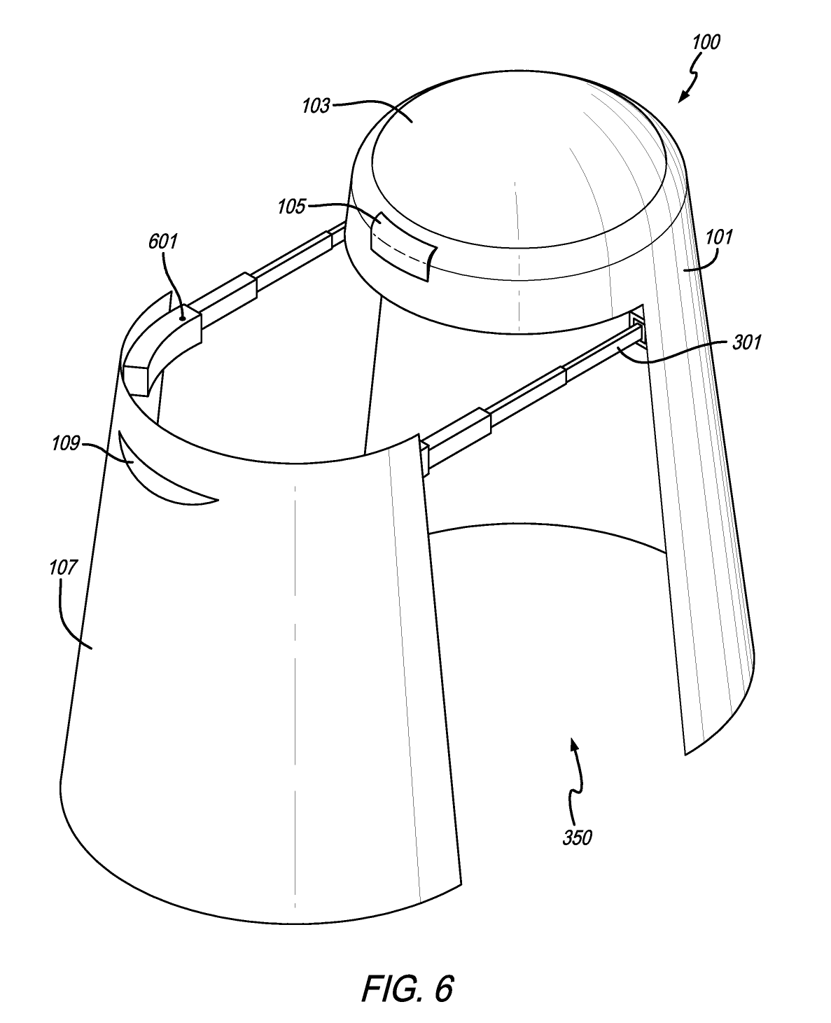

FIG. 6 is an illustration of a perspective view of one embodiment of the feminine waste disposal container without the disposable bag.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

FIG. 1 is an illustration of one embodiment of the feminine hygiene waste disposal container. As shown in FIG. 1, one embodiment of the feminine hygiene waste disposal container 100 may comprise: a body 101, lid 103, opening mechanism 105, front panel 107, and handle 109. The body 101 is preferably the main housing or structure that holds the inner workings or components of the feminine hygiene waste disposal container 100 and may comprise a top open end 203 (shown in FIG. 2) and front open end 350 (shown in FIG. 3). In a preferred embodiment, the top open end 203 and front open end 350 provide access to the inner cavity of the body 101. The lid 103 is generally a top cover for the top open end 203 of the body 101 and is preferably connected to the body 101 via a hinge. The opening mechanism 105 is preferably configured to actuate the opening of the lid 103 to provide access to the top open end 203 of the body 101 and may be embodied as a button or switch. The front panel 107 is preferably the front portion of the feminine hygiene waste disposal container 100 and is preferably removeably attached to the front open end 350 of the body 101. In a preferred embodiment, the shape of the front panel 107 is preferably contoured to the shape of the body 101, such that when the front panel 107 is attached to the front open end 350 of the body 101, the shape of the body 101 is substantially uniform all around. The handle 109 may be a structure or mount configured to be grasped by the hand of the user, so that, the front panel 107 may be pulled away from the body 101. Although the handle 109 may projection from the front panel 107, it may be, as preferred, flush and integral to the front panel 107.

FIG. 2 is an illustration of another perspective view of one embodiment of the feminine hygiene waste disposal container and shows the feminine hygiene waste disposal container with the lid in an open position. As shown in FIG. 2, one embodiment of the feminine hygiene waste disposal container 100 may comprise: a body 101, lid 103, opening mechanism 105, front panel 107, handle 109, gasket 201, and disposable bag 205. The body 101 may comprise a top open end 203, which may be covered by the hinged lid 103. The disposable bag 205 may comprise a ring 207 and a second fastener 209. Importantly, FIG. 2 shows that the lid 103 may be in an open position and may be configured to open via the opening mechanism 105. In the embodiment shown in FIG. 2, when the opening mechanism 105 is activated by pressing or pushing the button, the hinged lid 103 may move upwards, uncovering the top open end 203 and exposing the inner cavity of the body 101. FIG. 2 also shows that the lid 103 may comprise a gasket 201, which is preferably adapted to minimize the odor emanating from the body 101 when the lid 103 is in a closed position, as shown in FIG. 1. Inside the body 101, the disposable bag 205 may comprise a ring 207 with a second fastener 209. The ring 207 may be removeably attached to the rim of the disposable bag 205, and the second fastener 209 may be used to fasten the disposable bag 205 to the body 101 or the telescopic guide rails 301 of the feminine hygiene waste disposal container 100 (shown in FIG. 3). Although FIG. 2 shows that the lid 103 may be opened by an opening mechanism such as a button, the lid may be opened by other forms of opening mechanisms such as a switch. Although FIG. 2 shows that the lid 103 may be hinged, the lid may also be non-hinged, removable, threaded, and/or friction fitted.

FIG. 3 is an illustration of another perspective view of one embodiment of the feminine hygiene waste disposal container and shows the front panel away from the body with the telescopic guide rails extended. As shown in FIG. 3, one embodiment of the feminine hygiene waste disposal container 100 may comprise: a body 101, lid 103, opening mechanism 105, front panel 107, handle 109, disposable bag 205, ring 207, second fasteners 209, and telescopic guide rails 301. FIG. 3 also shows that the body may comprise a front open end 350 when the front panel 107 is pulled away from the body 101. The telescopic guide rails 301 are generally tracks or rails designed to control and enable movement of the front panel and may be configured to connect the front panel 107 to the body 101 or extend the front panel 107 away from the body 101. Specifically, the proximal ends or front ends of the telescopic guide rails 301 may connect to the rear side of the front panel 107 while the distal ends or rear ends of the telescopic guide rails 301 may be connected to a rear receiving fitting on said inner cavity of the body 101. The rear receiving fitting may be a rail frame or structure configured to hold, receive, and secure the telescopic guide rails 301 when the telescopic guide rails 301 are retracted or collapsed into the inner cavity of the body 101. In one embodiment, each of the telescopic guide rails may comprise: (1) a body rail that may be fixed to the inner cavity of the body 101; (2) a front panel rail that may be fixed to the rear side of the front panel 107; and (3) one or more middle rails placed in-between the body rails and front panel rails. In an alternative embodiment, the telescopic guide rails may lack middle rails, such that each telescopic guide rail may include: only a body rail and a front panel rail. In this embodiment, the distal end of the body rail may be attached to the inner cavity of the body 101; the proximal end of the body rail may be moveably connected to the distal end of the front panel rail; and the proximal end of the front panel rail may be affixed to the rear side of the front panel 107. The handle 109 may be a structure or mount configured to be grasped by the hand of the user, such that, when pulled, the front panel 107 may be moved away from the body 101 and the telescopic guide rails may be extended. The ring 207 may be affixed to the rim of the disposable bag 205. The proximal end portion of the telescopic guide rails 301 may be configured to engage, hold, and/or secure the ring 207 and disposable bag 205. The ring 207 may also have one or more second fasteners 209 to assist in holding and securing the disposable bag 205 to the telescopic guide rails 301. Although the waste disposal container 100 is shown as round, generally cylindrical or conical, in other embodiments, other shapes may be used, such as organic, square, rectangular, and cubed. Additionally, although FIG. 3 shows telescopic guide rails, other various forms of guide rails may be used.

FIG. 4 is an illustration of a perspective view of one embodiment of the disposable bag. FIG. 4 is also shows the disposable bag in an open position. As shown in FIG. 4, one embodiment of the disposable bag 400 may comprise: a ring 207 and a bag 407. The ring 207 may be affixed to the rim of the bag 407 and may be adapted to provide easy access to the inner cavity of the bag 407. FIG. 4 also shows that the ring 207 may comprise: a female second fastener 401, male second fastener 403, hinges 405, first ring portion 410, and second ring portion 411. The hinges 405 may be configured to allow the ring 207 to fold the first ring portion 410 towards the second ring portion 411, such that the hinge 405 facilitates the closing of the disposable bag 400. Once closed, the ring 207 may be substantially semi-circular shape and may allow the disposable bag 400 to close and secure its contents therewith. The female second fastener 401 and male second fastener 403 may be configured to mate and engage with one another, such that, when the ring 207 is folded or closed, the disposable bag 400 is sealed. Although the disposable bag 400 and ring 207 as shown as round, generally cylindrical or conical, in other embodiments, other shapes may be used, such as organic, square, rectangular, polygonal, and cubed.

FIG. 5 is an illustration of a perspective view of one embodiment of the disposable bag and shows the disposable bag in a closed position. As shown in FIG. 5, one embodiment of the disposable bag 400 may comprise; a ring 207 and a bag 407. The ring 207 may further comprise: a female second fastener 401, male second fastener 403, hinge 405, first ring portion 410, and second ring portion 411. The female second fastener and male second fastener may be configured to matingly engage with one other, such that said disposable bag 400 closes when the female second fastener and male second fastener matingly engage. The hinge may be configured to allow the ring 207 to fold, such that the crease facilitates the flush closing of the disposable bag 400. FIG. 5 also shows that the ring 207 may be substantially semicircular in shape when the disposable bag 400 is in a closed position.

FIG. 6 is an illustration of a perspective view of one embodiment of the feminine waste disposal container without the disposable bag. As shown in FIG. 6, one embodiment of the feminine hygiene waste disposal container 100 may comprise: a body 101, lid 103, opening mechanism 105, front panel 107, handle 109, first fasteners 601, and telescopic guide rails 301. The telescopic guide rails 301 may be configured to connect the front panel 107 to the main body 101. Specifically, the proximal end of the telescopic guide rails 301 may connect to the rear side of the front panel 107 while the distal end of the telescopic guide rails may be connected to an inner cavity of the main body 101. The handle 109 may be configured such that, when pulled, the front panel 107 moves away from the main body 101 and the telescopic guide rails may extend, as shown in FIG. 6. The telescopic guide rails 301 may also be configured to engage and hold the ring and disposable bag.

FIG. 6 also shows that the telescopic guide rails 301 may further comprise first fasteners 601. In one embodiment, the first fasteners 601 may comprise a female first fastener and a male first fastener. The female first fastener may be configured to engage the male second fastener, and the male first fastener may be configured to engage the female second fastener, such that the female first fastener and male first fastener may hold and/or secure the disposable bag 400.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A feminine hygiene waste disposal container, comprising:
a body;
a lid;
a front panel;
one or more guide rails; and
one or more first fasteners;
wherein said body comprises a top open end and a front open end;
wherein said top open end and said front open end provides access to an inner cavity of said body;
wherein said lid is removeably mounted on said top open end of said body and is adapted to substantially cover said top open end;
wherein said front panel is connected to a proximal ends of said one or more guide rails;
wherein a distal ends of said one or more guide rails are connected to said inner cavity of said body through said front open end and are adapted to be pushed onto a rear receiving fitting on said inner cavity of said body in a guiding direction, such that said front panel can be engaged with said front open end of said body; and
wherein said one or more first fasteners are positioned approximately near a proximal end portion of said guide rails and are adapted to securely hold and secure at least one disposable bag, such that, when said front panel is engaged with said front open end of said body and when said lid is in said closed position, said at least one disposable bag is substantially concealed.

2. The feminine hygiene waste disposal container of claim 1, wherein said one or more guide rails are telescopic guide rails.

3. The feminine hygiene waste disposal container of claim 2, wherein said lid is pivotally mounted on said top open end of said body via a hinge, such that said lid is configured to be selectively movable between an open position and a closed position.

4. The feminine hygiene waste disposal container of claim 3, wherein said at least one disposable bag comprises a ring and one or more second fasteners;
wherein said ring is attached to a rim of said at least one disposable bag, such that an inner opening of said ring provides sole access to said inner cavity of said at least one disposable bag; and
wherein said one or more second fasteners are located on said ring and are adapted to matingly engage with said one or more first fasteners, such that said at least one disposable bag may removeably connect to said proximal end portion of said one or more telescopic guide rails and may be held steady by said one or more telescopic guide rails.

5. The feminine hygiene waste disposal container of claim 4, wherein said inner cavity of said at least one disposable bag is accessible when said front panel is away from said body and when said one or more telescopic guide rails are substantially extended.

6. The feminine hygiene waste disposal container of claim 4, wherein said ring comprises one or more hinges to fold a first ring portion towards a second ring portion, such that said at least one disposable bag is adapted to move between an open position and a closed position.

7. The feminine hygiene waste disposal container of claim 6, wherein said one or more second fasteners of said at least one disposable bag are two fasteners, a male second fastener and a female second fastener; and
wherein said male second fastener and said female second fastener are adapted to mate and engage with each another, such that said first ring portion may be fastened to said second ring portion to securely close said at least one disposable bag.

8. The feminine hygiene waste disposal container of claim 4, wherein said front panel further comprises a handle;
wherein said handle is adapted to allow a user to pull said front panel away from said body and extend said one or more telescopic guide rails.

9. The feminine hygiene waste disposal container of claim 3, further comprising an opening mechanism;
wherein said opening mechanism is adapted to pivotally open said lid to said open position.

10. The feminine hygiene waste disposal container of claim 9, wherein said opening mechanism is selected from the group of opening mechanisms consisting of: a button and a switch.

11. The feminine hygiene waste disposal container of claim 3, further comprising:
a gasket;
wherein said gasket is located at an inner portion of said lid and is adapted to seal said top open end of said body when said lid is in said close position to prevent an odor from emanating from said feminine hygiene waste disposal container.

12. A feminine hygiene waste disposal container, comprising:
a body;
a lid;
a front panel;
at least two telescopic guide rails;
at least two first fasteners; and
at least one disposable bag;
wherein said body comprises a top open end and a front open end;
wherein said top open end and said front open end provides access to an inner cavity of said body;
wherein said lid is pivotally mounted on said top open end of said body via a hinge and is adapted to substantially cover said top open end;
wherein said lid is configured to be selectively movable between an open position and a closed position;
wherein said front panel is connected to a proximal ends of said at least two telescopic guide rails;
wherein a distal ends of said at least two telescopic guide rails are connected to said inner cavity of said body through said front open end and are adapted to be pushed onto a rear receiving fitting on said inner cavity of said body in a guiding direction, such that said front panel can be engaged with said front open end of said body; and
wherein said at least two first fasteners are positioned approximately near a proximal end portion of said telescopic guide rails and are adapted to securely hold and secure said at least one disposable bag, such that, when said front panel is engaged with said front open end of said body and when said lid is in said closed position, said at least one disposable bag is substantially concealed.

13. The feminine hygiene waste disposal container of claim 12, wherein said at least one disposable bag comprises a ring and at least two second fasteners;
wherein said ring is attached to a rim of said at least one disposable bag, such that an inner opening of said ring provides sole access to said inner cavity of said at least one disposable bag; and
wherein said at least two second fasteners are located on said ring and are adapted to matingly engage with said at least two first fasteners, such that said at least one disposable bag may removeably connect to said proximal end portion of said at least two telescopic guide rails and may be held steady by said at least two telescopic guide rails.

14. The feminine hygiene waste disposal container of claim 12, wherein said inner cavity of said at least one disposable bag is accessible when said front panel is away from said body and when said at least two telescopic guide rails are substantially extended.

15. The feminine hygiene waste disposal container of claim 12, wherein said ring comprises at least two hinges to fold a first ring portion towards a second ring portion, such that said at least one disposable bag is adapted to move between an open position and a closed position.

16. The feminine hygiene waste disposal container of claim 15, wherein said at least two second fasteners of said at least one disposable bag are two fasteners, a male second fastener and a female second fastener; and
wherein said male second fastener and said female second fastener are adapted to mate and engage with each another, such that said first ring portion may be fastened to said second ring portion to securely close said at least one disposable bag.

17. The feminine hygiene waste disposal container of claim 12, wherein said front panel further comprises a handle;
wherein said handle is adapted to allow a user to pull said front panel away from said body and extend said at least two telescopic guide rails.

18. The feminine hygiene waste disposal container of claim 12, further comprising an opening mechanism;
wherein said opening mechanism is adapted to pivotally open said lid to said open position.

19. The feminine hygiene waste disposal container of claim 18, further comprising:
a gasket;
wherein said gasket is located at an inner portion of said lid and is adapted to seal said top open end of said body when said lid is in said close position to prevent an odor from emanating from said feminine hygiene waste disposal container.

20. A feminine hygiene waste disposal container, comprising:
a body;
a lid;
a front panel;
two telescopic guide rails;
two first fasteners;
a disposable bag;
an opening mechanism; and
a gasket;
wherein said body comprises a top open end and a front open end;
wherein said top open end and said front open end provides access to an inner cavity of said body;
wherein said lid is pivotally mounted on said top open end of said body via a hinge and is adapted to substantially cover said top open end;
wherein said lid is configured to be selectively movable between an open position and a closed position;
wherein said front panel is connected to a proximal ends of said two telescopic guide rails;
wherein a distal ends of said two telescopic guide rails are connected to said inner cavity of said body through said front open end and are adapted to be pushed onto a rear receiving fitting on said inner cavity of said body in a guiding direction, such that said front panel can be engaged with said front open end of said body;
wherein each of said two first fasteners are positioned approximately near a proximal end portion of each of said telescopic guide rails and are adapted to securely hold and secure said disposable bag, such that, when said front panel is engaged with said front open end of said body and when said lid is in said closed position, said disposable bag is substantially concealed;
wherein said disposable bag comprises a ring and two second fasteners;
wherein said ring is attached to a rim of said disposable bag, such that an inner opening of said ring provides sole access to said inner cavity of said disposable bag;
wherein said two second fasteners are located on said ring and are adapted to matingly engage with said two first fasteners, such that said disposable bag may removeably connect to said proximal end portion of said two telescopic guide rails and may be held steady by said two telescopic guide rails;
wherein said inner cavity of said disposable bag is accessible said front panel is away from said body and when said two telescopic guide rails are substantially extended;
wherein said ring is foldable to a substantially semicircular shape, such that said inner cavity of said disposable bag may be closed;
wherein said ring comprises two hinges to fold a first ring portion towards a second ring portion, such that said disposable bag is adapted to move between an open position and a closed position;
wherein said two second fasteners of said at least one disposable bag are a male second fastener and a female second fastener;
wherein said male second fastener and said female second fastener are adapted to mate and engage with each another, such that said first ring portion may be fastened to said second ring portion to securely close said at least one disposable bag;
wherein said front panel further comprises a handle;
wherein said handle is adapted to allow a user to pull said front panel away from said body and extend said two telescopic guide rails;
wherein said opening mechanism is adapted to pivotally open said lid to said open position; and
wherein said gasket is located at an inner portion of said lid and is adapted to seal said top open end of said body when said lid is in said close position to prevent an odor from emanating from said feminine hygiene waste disposal container.
